(19) United States
(12) Patent Application Publication
(10) Pub. No.: US 2002/0123018 A1
(43) Pub. Date: Sep. 5, 2002

(54) Infrared generation

(76) Inventor: Gerard J. Lucidi, Moorestown, NJ (US)

Correspondence Address: CONNOLLY BOVE LODGE & HUTZ, LLP, 1220 N MARKET STREET, P O BOX 2207, WILMINGTON, DE, 19899

(21) Appl. No.: 09/798,127

(22) Filed: Mar. 2, 2001

(51) Int. Cl. B32B 27/04; F23D 14/12

(52) U.S. Cl. 431/328; 428/297.4

(57) ABSTRACT

Improved infrared generating matrix constructed of a mixture of non-carcinogenic, high temperature withstanding raw materials. The matrix fibrous components is a blend of at least two materials having a different temperature rating. At least one material is at least about 100 degrees C. above the maximum radiant face operating temperature and at least one material is at least below the maximum radiant face operating temperature.

### BACKGROUND OF THE INVENTION

Infrared (“IR”) heaters are used in equipment for treating substrates such as in the drying of paper. Particularly effective IR heaters are described in U.S. Pat. No. 4,722,681, 4,224,018; 5,024,596; 4,589,843; 5,464,346; 4,224,018; 4,604,054; 4,654,000; 4,500,283; 4,443,185; 4,474,552; 4,416,618; 4,447,205; 5,464,346. and 4,378,207 which are incorporated herein in their entirety for all purposes by reference thereto.

U.S. Pat. No. 4,722,681 describes a IR heater body having a plenum chamber divided by a baffle into an unbaffled upstream intake compartment and a baffled downstream intake compartment. A matrix is located at the downstream end of the downstream intake compartment. The matrix is disclosed as being made from ceramic fibers about one inch thick and is adhesively secured to the side walls of the IR heater body. The matrix is formed as a block wherein its side walls are perpendicular to its top and bottom walls. The matrix fits against the comparably shaped end portions of the side walls of the IR heater body.

There has been a need to develop an improved highly emittance matrix that is made of a mixture of non-carcinogenic, high temperature withstanding raw materials.

### SUMMARY OF THE INVENTION

An object of the invention is to develop an improved infrared generating matrix constructed of a mixture of non-carcinogenic, high temperature withstanding raw materials.

An infrared generating matrix comprising a mixture of at least two different non-carcinogenic, high temperature withstanding materials wherein at least one material is at least about 100 degrees C. above the maximum radiant face operating temperature and at least one material is at or below the maximum radiant face operating temperature.

### DETAILED DESCRIPTION OF THE INVENTION

The improved infrared generating matrix according to the invention is constructed of a mixture of non-carcinogenic, high temperature withstanding raw materials through the thickness of which can be passed a gas air mixture that is combusted approximately 2 to 5 mm within the emerging surface causing a high level of infrared energy to be radiated outward to a work piece to be heat treated. The matrix fibrous components is a blend of at least two materials having a different temperature rating. At least one material is at least about 100 degrees C. above the maximum radiant face operating temperature and at least one material is at or below the maximum radiant face operating temperature. During high temperature operation of an infrared generating matrix having a fiber mixture described above, the lower temperature fibers soften and wet to the higher temperature fibers forming a thin tough layer that is substantially more resistant to abrasion than a matrix comprised of only high temperature fibers.

The matrix is made by blending at least two different maximum temperature rated materials together. At least one material is at least about 100 degrees C. above the maximum radiant face operating temperature and at least one material is at or below the maximum radiant face operating temperature. The mixture contains from about 50% to about 90% and more preferably from 65% to 85% of the at least one material is at least about 100 degrees C. above the maximum radiant face operating temperature. The mixture contains from about 10% to about 50% and more preferably from 15% to 35% of the at least one material that is at or below the maximum radiant face operating temperature.

The matrix is made of fibers and optionally other ingredients that can be added, such as, but not limited to, binders, opacificers and water proofing agents.

Examples of materials that can be used are two materials from Thermal Ceramics called SUPERWOOL 607® and SUPERWOOL 607 MAX™ which are materials made from calcium-magnesium-silicate. These light weight wool materials are an alternative to traditional solutions due to its unique properties of high refractoriness and excellent non-wetting characteristics in applications requiring direct contact with molten aluminum. Superwool 607 has a melting point of 1470° C. and a maximum temperature rating of 1100° C. Superwool 607 Max has a melting point of 1500° C. and a maximum temperature rating of 1260° C.

The present invention relates to apparatus and methods for treating substrates such as webs of paper, textile and non-woven, which are manufactured in long lengths and are heat-treated during of after their manufacture.

According to another aspect of the present invention, the improved infrared generating matrix contains materials as described in U.S. Pat. No. 4,722,681, which is incorporated by referenced in its entirety for all useful purposes. The improvement according to the present invention is the use of fibers designed from pure raw materials (Calcium, Magnesium and Silicate), which are exonerated from any carcinogenic classification in the countries of the European Union under provisions of Directive 97/69/EC. Fibers manufactured from these pure raw materials are more soluble in body fluids than fibers previously used for manufacturing infrared generating matrices.

### EXAMPLE

Approximately ⅓ by weight of fibers having a recommended use limit of 1000 C. are blended with approximately ⅔ by weight of fibers having a recommended use limit of 1200° C. The fibers used are SUPERWOOL 607. This blend has a unexpectedly desirable characteristic which causes the lower temperature use limit fibers to soften and wet to the higher temperature use limit fibers forming a thin tough abrasion resistant layer in the 2 to 5 mm thick combustion zone of the gas/air emerging side of the infrared emitting matrix. Abrasion resisting tests show this layer to be at least 30% more resistant to abrasion than previously manufactured matrices.

All the patents and publications are incorporated by reference in their entirety, for all useful purposes including all the drawings.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

I claim:

1. An infrared generating matrix comprising a mixture of at least two different non-carcinogenic, high temperature withstanding materials wherein at least one material is at least about 100 degrees C. above the maximum radiant face operating temperature and at least one material is at or below the maximum radiant face operating temperature.

2. The infrared matrix as claimed in claim 1, wherein said mixture contains from about 50% to about 90% by weight of said at least one material is at least about 100° C. above the maximum radiant face operating temperature.

3. The infrared matrix as claimed in claim 1, wherein said mixture contains from about 65% to about 85% by weight of the at least one material is at least about 100° C. above the maximum radiant face operating temperature.

4. The infrared matrix as claimed in claim 1, wherein said mixture contains from about 10% to about 50% by weight of said at least one material that is at or below the maximum radiant face operating temperature.

5. The infrared matrix as claimed in claim 1, wherein said mixture contains from about 15% to about 35% weight of said at least one material that is at or below the maximum radiant face operating temperature.

6. The infrared matrix as claimed in claim 2, wherein said mixture contains from about 10% to about 50% by weight of said at least one material that is at or below the maximum radiant face operating temperature.

7. The infrared matrix as claimed in claim 3, wherein said mixture contains from about 15% to about 35% weight of said at least one material that is at or below the maximum radiant face operating temperature.

8. The infrared matrix as claimed in claim 1, which further comprises a binder.

9. The infrared matrix as claimed in claim 1, which further comprises a water proofing agent.

10. The infrared matrix as claimed in claim 1, which further comprises an opacificer.

11. The infrared matrix as claimed in claim 7, which further comprises a binder.

12. The infrared matrix as claimed in claim 7, which further comprises a water proofing agent.

13. The infrared matrix as claimed in claim 7, which further comprises an opacificer.

14. The infrared matrix as claimed in claim 7, which further comprises a binder, a water proofing agent and an opacificer.

15. The infrared matrix as claimed in claim 7, which further comprises a binder.

16. An infrared generating matrix comprising a mixture of at least two different non-carcinogenic, fibers wherein about one third by weight of the fibers have a use limit of 1000° C. are blended with about two thirds by weight of fibers having a use limit of 1200° C.

17. The infrared matrix as claimed in claim 16, wherein the fibers having the use limit of 1000° C. soften and wet to the fibers having the use limit of 1200° C. and forming a layer of about 2 to about 5 mm thick

18. The infrared matrix as claimed in claim 16, wherein the fibers having the use limit of 1000° C. and the fibers having the use limit of 1200° C. are made from at least calcium, magnesium or silicate.

19. The infrared matrix as claimed in claim 17, wherein the fibers having the use limit of 1000° C. and the fibers having the use limit of 1200° C. are made from calcium, magnesium and silicate.

20. The infrared matrix as claimed in claim 7, wherein said at least one material is at least about 100 degrees C. above the maximum radiant face operating are fibers made of calcium, magnesium and silicate and said at least one material is at or below the maximum radiant face operating temperature are fibers made from calcium, magnesium and silicate
